(19) United States
(12) Patent Application Publication
(10) Pub. No.: US 2009/0100947 A1
(43) Pub. Date: Apr. 23, 2009

(54) MEASURING DEVICE COMPRISING A PROBE BODY ADAPTED FOR CONNECTION WITH A PROCESS VESSEL OR CONDUIT AND MEASURING METHOD

(75) Inventor: Trevor Gordon Page, Southampton (GB)

Correspondence Address: SUGHRUE MION, PLLC, 2100 PENNSYLVANIA AVENUE, N.W., SUITE 800, WASHINGTON, DC, 20037, US

(73) Assignee: AEROMATIC-FIELDER AG, BUBENDORF (CH)

(21) Appl. No.: 12/095,070

(22) PCT Filed: Dec. 5, 2006
(86) PCT No.: PCT/IB2006/054594

§ 371 Date: Sep. 23, 2008

(30) Foreign Application Priority Data
Dec. 21, 2005 (DK) PA 2005 01806

(51) Int. Cl. G01D 21/00; G06F 15/00

(52) U.S. Cl. 73/866.5; 702/127

(57) ABSTRACT

A measuring device (1) comprises a probe body (4) adapted for connection with a process vessel or conduit, so that a process opening (6) of the probe body communicates with the interior of the process vessel or conduit. A front valve (7) is arranged between the process opening and a washing chamber (5) in the probe body, and a probe piston (3) is arranged displaceably in the probe body between a retracted position, in which the probe piston is located behind the front valve (7), inside the washing chamber (5), and an extended position, in which the probe piston extends through the front valve and communicates with the process opening. A back valve (9) is arranged between the front valve and the washing chamber, and an intermediate chamber (8) is arranged between the front valve and the back valve. In its retracted position, the probe piston is located behind the back valve.

The present invention relates to a measuring device comprising a probe body adapted for connection with a process vessel or conduit, so that a process opening of the probe body communicates with the interior of the process vessel or conduit, a front valve arranged between the process opening and a washing chamber in the probe body, and a probe piston arranged displaceably in the probe body between a retracted position, in which the probe piston is located behind the front valve, inside the washing chamber, and an extended position, in which the probe piston extends through the front valve and communicates with the process opening.

U.S. Pat. No. 3,691,846 describes a measuring instrument equipped with a removable measured value transmitter probe, whereby the probe in its operating position communicates via an opening with a processing compartment. In a retracted position of the probe, the probe is located in a surrounding chamber, in which it may be sterilized. Between said opening and the surrounding chamber, a shut-off element is arranged. In the operating position, the probe extends through the shut-off element, and in the retracted position, the shut-off element is closed. However, if a washing fluid containing detergents is employed for washing the probe in the surrounding chamber, there is a risk that washing fluid may pass the shut-off element and pollute the product being processed in the processing compartment. This is, for instance in the pharmaceutical industry, not acceptable.

The object of the present invention is to provide a measuring device permitting washing of the probe piston during processing, whereby the risk of polluting the product being processed in the process vessel or conduit with the washing fluid is reduced considerably.

In view of this object, a back valve is arranged between the front valve and the washing chamber, an intermediate chamber is arranged between the front valve and the back valve, and the probe piston, in its retracted position, is located behind the back valve.

In this way, both the front valve and the back valve may be closed during washing of the probe piston in the retracted position of the latter, whereby washing fluid possibly leaking through the back valve may be taken up by the intermediate chamber, so that the risk that washing fluid will be able to leak through the front valve and thereby enter the process vessel or conduit is considerably reduced.

In an advantageous embodiment, the intermediate chamber is adapted to communicate with a drain in the retracted position of the probe piston. Thereby, the risk of washing fluid entering the process vessel or conduit is further reduced, because even large quantities of washing fluid possibly leaking through the back valve will be drained away from the intermediate chamber by the drain.

In an advantageous embodiment, the intermediate chamber is connected with a first and a second valve, each valve being adapted for connection with a drain, a washing fluid supply, a drying air supply or a vacuum pipe. In this way, the intermediate chamber may be washed independently of the washing chamber. For instance, the intermediate chamber may be rinsed by means of clean water during washing of the probe piston in the washing chamber by means of washing fluid. Thereby, the risk of washing fluid entering the process vessel or conduit is further reduced, because washing fluid possibly leaking through the back valve would be rinsed away by the clean water running through the intermediate chamber. Furthermore, the intermediate chamber may be washed by means of washing fluid at the end of the process in the process vessel or conduit.

In an advantageous embodiment, the washing chamber is connected with a first and a second washing valve, each valve being adapted for connection with a drain, a washing fluid supply or a drying air supply. Thereby, efficient washing and drying of the probe piston in the washing chamber may be ensured.

In an advantageous embodiment in terms of structure and manufacture, the probe body has the form of a block composed by two mating halves, and the intermediate chamber, the washing chamber and connections for these are formed as recesses in the contact surfaces of said two halves.

In an advantageous embodiment in terms of structure and operation, each valve has the form of a pinch valve incorporating an inflatable tube element arranged with its ends sealingly abutting a corresponding recess in the block, so that an air chamber is formed between the outer periphery of the tube element and the block, and a separate air supply for the air chamber of each tube element is arranged in the block for the inflation of the tube element. Thereby, advantageously at least the front valve may be closed around the periphery of the probe piston in the extended position of the latter, whereby it is avoided that process material may enter the probe body from the process vessel or conduit during measurements.

In an embodiment, the probe piston enters the washing chamber opposite the back valve through a pinch valve. Thereby, an efficient seal to the surroundings may be obtained by closing the pinch valve around the periphery of the probe piston during washing of the probe piston.

In an embodiment, the measuring device is controlled by means of a computer to perform a measuring operation comprising the following steps: performing a measurement in the extended position of the probe piston, displacing the probe piston to its retracted position, closing the front and back valves, opening the washing valves, supplying and draining washing fluid to and from the washing chamber, opening the front and back valves, and displacing the probe piston to its extended position. Thereby, the above-mentioned advantages may be obtained.

The invention further relates to a measuring method, whereby, during processing, a measurement is performed in a process vessel or conduit by means of a probe piston extending through a front valve in a probe body connected with the process vessel or conduit, whereby the probe piston is retracted into a washing chamber in the probe body after said measurement, and the front valve is closed, whereby the probe piston is washed by means of washing fluid in the washing chamber, and whereby the front valve is subsequently opened, and the probe piston is extended through the front valve in order to perform another measurement.

The measuring method is characterized by that, during the measurements, the probe piston extends through a back valve located between the front valve and the washing chamber, and by that the back valve is closed before and opened after the washing of the probe piston. Thereby, the above-mentioned advantages may be obtained.

In an embodiment, during the washing of the probe piston, the intermediate chamber is connected with a drain and the washing chamber is connected with a first and a second washing valve, each valve being sequentially connected to a drain, a washing fluid supply and a drying air supply, respectively. Thereby, the above-mentioned advantages may be obtained.

In an embodiment, after the end of the process, the interior of the probe body is washed by means of washing fluid supplied and drained to and from the intermediate chamber by means of a first and a second valve, respectively, and by means of washing fluid supplied and drained to and from the washing chamber by means of the first and the second washing valve, respectively, whereby washing fluid is flowing through the back valve and the front valve into the process vessel or conduit, and whereby all valves in the probe body are operated sequentially. Thereby, the measuring device may be washed very efficiently between the processing of different materials in the process vessel or conduit.

In an embodiment, all the valves in the probe body are operated by means of inflation of a tube element arranged with its ends sealingly abutting a corresponding recess in the block, so that an air chamber is formed between the outer periphery of the tube element and the probe body, whereby air is supplied to the air chamber of each tube element from a separate air supply. Thereby, the above-mentioned advantages may be obtained.

The invention will now be explained in more detail below by means of examples of embodiments with reference to the very schematic drawing, in which

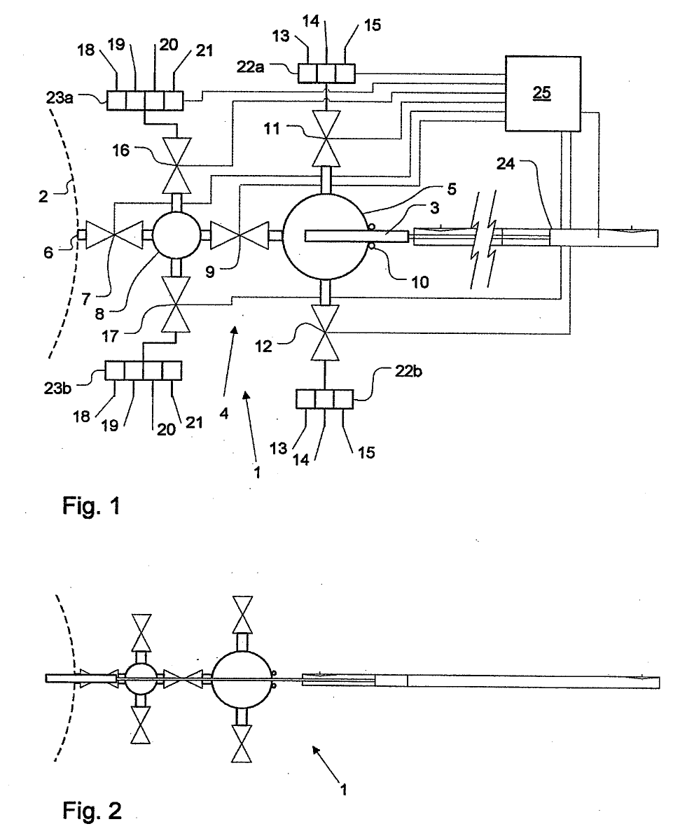

FIG. 1 is a diagram showing the measuring device according to the invention, whereby the probe piston is in its retracted position,

FIG. 2 is a diagram corresponding to FIG. 1, whereby the probe piston is in its extended position,

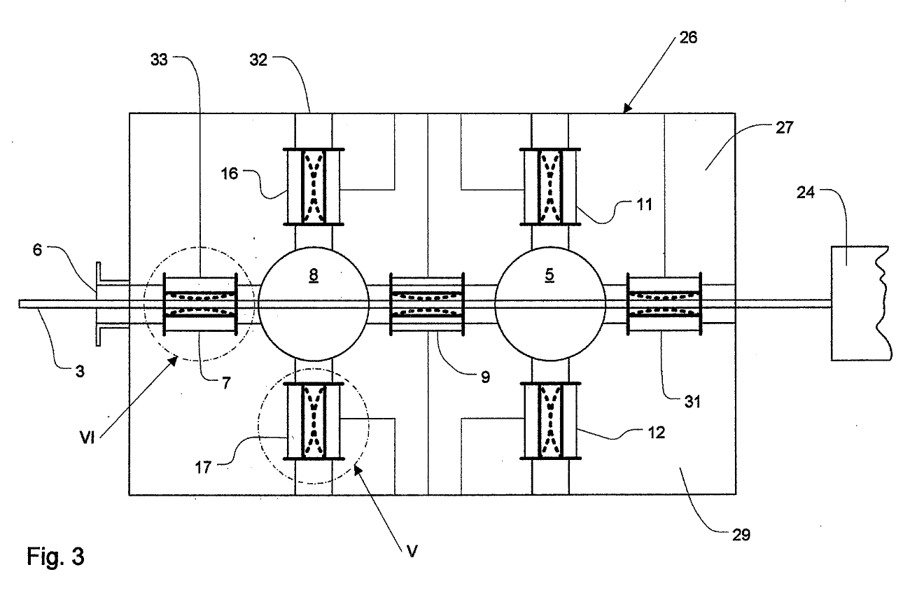

FIG. 3 is a longitudinal cross-section of an embodiment of the measuring device in FIGS. 1 and 2,

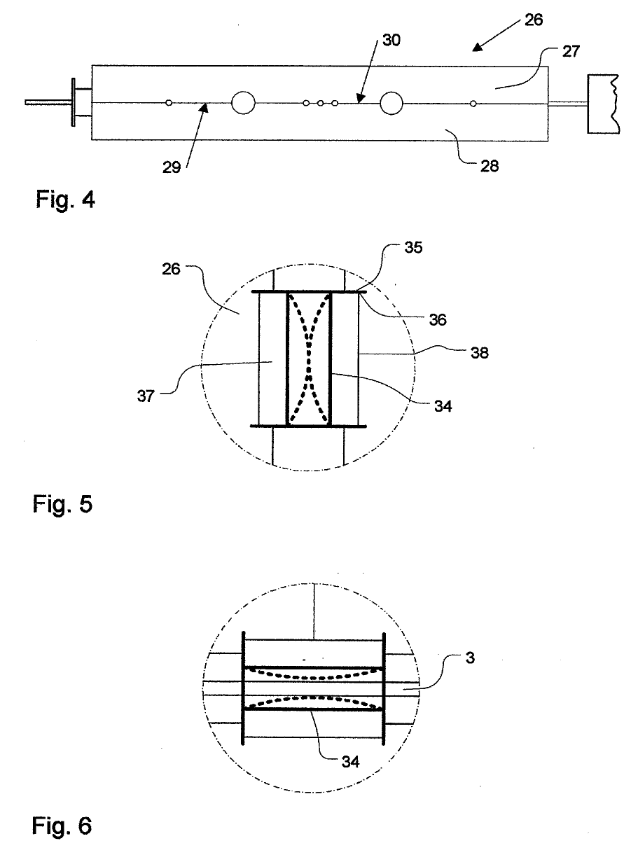

FIG. 4 is a side view of the embodiment shown in FIG. 3,

FIG. 5 shows in greater detail a part indicated by V in FIG. 3,

FIG. 6 shows in greater detail a part indicated by VI in FIG. 3, and

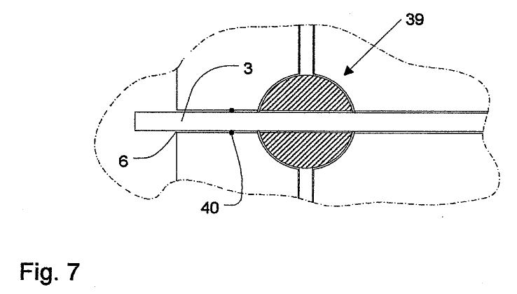

FIG. 7 shows an alternative embodiment of a front valve of the measuring device according to the invention.

FIGS. 1 and 2 show diagrammatic a measuring device 1 according to the invention, mounted on a process vessel or conduit, of which only a wall part 2 is shown by means of a dashed line. The process vessel may be, for instance, a granulator or a fluid bed apparatus used for granulating and/or drying a powdered or particulate product, such as a pharmaceutical product, or a health care product, which may, for instance, have been produced in a spray drying process or in an extrusion process. The process vessel, on which the measuring device 1 is mounted, may also be a spray drying apparatus. However, the invention is also applicable for fluid bed reactors in general and in fact any kind of process vessel or conduit containing or transporting a product on which a measurement is to be performed. The product may be any kind of bulk material, powder, granulated or agglomerated material, fluid or gas.

The measuring device 1 comprises a probe piston 3 arranged displaceably in a probe body 4 between a retracted position, shown in FIG. 1, in which the probe piston 3 is located in a washing chamber 5, and an extended position, shown in FIG. 2, in which the probe piston 3 extends into the process vessel or conduit. The probe piston 3 comprises a not shown probe in the form of a measuring instrument or sampling instrument. The measuring instrument may communicate with equipment located outside the measuring device 1 for instance by means of a fibre optic light guide, an electric cable or other suitable means. The probe may be equipped with a window in an end or peripheral surface of the probe piston 3, associated with a near-infrared (NIR) device or a device based on another analysis technology, for instance such as microwaves, in order to monitor product characteristics, such as residual moisture. In the case of a sampling instrument, the probe may have the form of a small container adapted to accommodate a sample of the material present in the process vessel or conduit.

I should be noted, however, that the probe piston 3 does not necessarily need to extend into the process vessel or conduit in its extended position, it may for instance be located inside the probe body 4 in such a way that it may communicate with the process vessel or conduit. This may be the case, if the probe is provided with a window, through which the measurements are performed, in the end face of the probe piston.

As shown in FIGS. 1 and 2, the probe body 4 is connected with the process vessel or conduit so that a process opening 6 of the probe body 4 opens into the process vessel or conduit. The process opening 6 is arranged in-line, in succession, with a front valve 7, an intermediate chamber 8, a back valve 9, the washing chamber 5 and a sliding seal 10, such as an O-ring, through which the probe piston 3 may enter the washing chamber 5.

The washing chamber is connected with a first and a second washing valve 11, 12, each of which, by means of a three-way valve 22a, 22b, is adapted to be connected with a drain 13, a washing fluid supply 14 or a drying air supply 15. The intermediate chamber 8 is connected with a first and a second valve 16, 17, each of which, by means of a four-way valve 23a, 23b, is adapted to be connected with a drain 18, a washing fluid supply 19, a drying air supply 20 or a vacuum pipe 21.

The probe piston 3 is displaceable between its retracted and its extended positions by means of a linear actuator 24, such as a pneumatic actuator. All valves 7, 9, 11, 12, 16, 17, 22, 23 and the linear actuator 24 are controlled by means of a computer 25.

To perform a measurement, the probe piston 3 is by means of the actuator 24 located in its extended position, as shown in FIG. 2, whereby the not shown probe comprised by the piston 3 may perform measurements on material that is being processed in the process vessel or is transported in the process conduit. After a certain period of time, whereby the probe piston 3 extends into the process vessel or conduit, the not shown probe may be covered by a thin layer of the material being processed or transported, so that accurate measurements may no longer be performed. Therefore, the probe piston 3 may, by means of the actuator 24, be displaced to its retracted position shown in FIG. 1, whereby the probe piston 3, or at least the part thereof containing the not shown probe, is located inside the washing chamber 5.

After retraction of the probe piston 3 through the front valve 7 and the back valve 9, these valves are closed, and the intermediate chamber 8 is connected to the drain 18 by means of the lower intermediate valve 17 and the four-way valve 23b. Subsequently, the part of the probe piston 3 located in the washing chamber 5 is washed by means of washing liquid supplied to and drained from the washing chamber 5 by means of the first and second washing valves 11, 12, respectively, one of which is connected with the washing fluid supply 14 through one of the three-way valves 22a, 22b, and the other of which is connected with the drain 13 through the other one of the three-way valves 22a, 22b. After the washing, the part of the probe piston 3 located in the washing chamber 5 is dried by means of drying air supplied through one of the first and second washing valves 11, 12 and a corresponding one of the three-way valves 22a, 22b.

Because the intermediate chamber 8 is connected to the drain 18 during the washing of the probe piston 3 in the washing chamber, in the event of washing fluid leaking through the back valve 9, the washing fluid would not be able to enter the process vessel or conduit through the front valve 7, as it would instead be drained from the intermediate chamber 8 to the drain 18. However, in order to obtain an even higher degree of safety against said leakage, clean water may be supplied to the intermediate chamber through one of the first and second valves 16, 17 from a not shown supply of clean water during the washing of the probe piston 3 in the washing chamber.

When the probe piston 3 has been washed in the washing chamber 5, the front valve 7 and the back valve 9 are opened again, and the probe piston 3 is extended to its extended position shown in FIG. 2, so that further measurements may be performed.

After processing a batch of material in the process vessel, or after a certain process time, during which material has been processed in the process vessel or has been transported through the process conduit, and during which measurements have been performed, and the probe piston 3 has been washed a number of times, the interior of the probe body 4 and all internal parts, such as the probe piston 3 and the valves 7, 9, 11, 12, 16, 17, 22, 23 may be washed or cleaned, by a so-called CIP (Cleaning In Place) or WIP (Washing In Place) procedure, whereby washing fluid may be supplied to and drained from the interior of the probe body 4 in alternating directions through the probe body 4 by means of the valves 7, 9, 11, 12, 16, 17, 22, 23, all of which may be operated sequentially during said washing or cleaning procedure. During the washing or cleaning procedure, the probe piston 3 may also be displaced to-and-fro and washing fluid may flow from the probe body 4 through the process opening 6 into the process vessel or conduit.

FIG. 3 shows a longitudinal cross-section through an embodiment of the measuring device 1, whereby the probe body has the form of a block 26 composed by two mating halves 27, 28. All the valves 7, 9, 11, 12, 16, 17, 22, 23 have the form of pinch valves which are located in recesses formed in each of two opposed contact faces 29, 30 of the two mating halves 27, 28, respectively. Correspondingly, the intermediate chamber 8 and the washing chamber 5 as well as connecting conduits between these are formed as recesses in each of the two opposed contact faces 29, 30. Furthermore, the sliding seal 10, through which the probe piston 3 enters the washing chamber 5, of the embodiment shown in FIGS. 1 and 2 is replaced by a pinch valve 31 corresponding to the other valves 7, 9, 11, 12, 16, 17, 22, 23. Thereby, the number of different parts is reduced.

The first and second valve 16, 17 and the first and second washing valve 11, 12 have connections 32 in the outer wall of the block 26. Correspondingly, each pinch valve 7, 9, 11, 12, 16, 17, 22, 23, 31 of this embodiment has a connection 33 in the outer wall of the block 26 for connection with a supply of compressed air for the activation of the valve.

FIG. 5 shows the pinch valve 17 of the embodiment shown in FIGS. 3 and 4. The pinch valve comprises an inflatable, elastic tube element 34 having opposed end collars 35 sealingly abutting corresponding recesses 36 in the block 26 so that an air chamber 37 is formed between the outer periphery of the tube element 34 and the block 26. A separate air supply 38 for the air chamber 37 of the tube element 34 is arranged in the block for the inflation of the tube element. The uninflated state of the tube element 34 is indicated with continuous lines, and the inflated state is indicated with broken lines. It is seen that the passage through the pinch valve is closed in the inflated state.

FIG. 6 shows the front valve 7 of the embodiment shown in FIG. 3. It is seen that, in the inflated state of the tube element 34 indicated with broken lines, the tube element 34 abuts the periphery of the probe piston 3 and thereby closes the passage through the front valve 7.

FIG. 7 shows another embodiment of the measuring device 1 according to the invention, whereby the front valve is a ball valve 39. In this case, an O-ring 40 is arranged in the conduit between the process opening 6 and the front valve 39, in order to seal the probe body against the process vessel or conduit during measurements, whereby the probe piston 3 is in its extended position. The other valves of the measuring device 1 according to the invention may also be ball valves or any other suitable kind of valve, such as a plug valve.

1. A measuring device comprising a probe body adapted for connection with a process vessel or conduit, so that a process opening of the probe body communicates with the interior of the process vessel or conduit, a front valve arranged between the process opening and a washing chamber in the probe body, and a probe piston arranged displaceably in the probe body between a retracted position, in which the probe piston is located behind the front valve, inside the washing chamber, and an extended position, in which the probe piston extends through the front valve and communicates with the process opening, characterized in that a back valve is arranged between the front valve and the washing chamber, in that an intermediate chamber is arranged between the front valve and the back valve, and in that the probe piston, in its retracted position, is located behind the back valve.

2. A measuring device according to claim 1, characterized in that the intermediate chamber is adapted to communicate with a drain in the retracted position of the probe piston.

3. A measuring device according to claim 1, characterized in that the intermediate chamber is connected with a first and a second valve, each valve being adapted for connection with a drain, a washing fluid supply, a drying air supply or a vacuum pipe.

4. A measuring device according to claim 1, characterized in that the washing chamber is connected with a first and a second washing valve, each valve being adapted for connection with a drain, a washing fluid supply or a drying air supply.

5. A measuring device according to claim 1, characterized in that the probe body has the form of a block composed by two mating halves, and in that the intermediate chamber, the washing chamber and connections for these are formed as recesses in the contact surfaces of said two halves.

6. A measuring device according to claim 5, characterized in that each valve has the form of a pinch valve incorporating an inflatable tube element arranged with its ends sealingly abutting a corresponding recess in the block, so that an air chamber is formed between the outer periphery of the tube element and the block, and in that a separate air supply for the air chamber of each tube element is arranged in the block for the inflation of the tube element.

7. A measuring device according to claim 6, characterized in that the probe piston enters the washing chamber opposite the back valve through a pinch valve.

8. A measuring device according to claim 1, characterized in that the measuring device is controlled by means of a computer to perform a measuring operation comprising the following steps:
performing a measurement in the extended position of the probe piston,
displacing the probe piston to its retracted position,
closing the front and back valves,
opening the washing valves,
supplying and draining washing fluid to and from the washing chamber,
opening the front and back valves,
and displacing the probe piston to its extended position.

9. A measuring method, whereby, during processing, a measurement is performed in a process vessel or conduit by means of a probe piston extending through a front valve in a probe body connected with the process vessel or conduit, whereby the probe piston is retracted into a washing chamber in the probe body after said measurement, and the front valve is closed, whereby the probe piston is washed by means of washing fluid in the washing chamber, and whereby the front valve is subsequently opened, and the probe piston is extended through the front valve in order to perform another measurement, characterized by that, during the measurements, the probe piston extends through a back valve located between the front valve and the washing chamber, and by that the back valve is closed before and opened after the washing of the probe piston.

10. A measuring method according to claim 9, characterized by that, during the washing of the probe piston, the intermediate chamber is connected with a drain and the washing chamber is connected with a first and a second washing valve, each valve being sequentially connected to a drain, a washing fluid supply and a drying air supply, respectively.

11. A measuring method according to claim 9, characterized by that, after the end of the process, the interior of the probe body is washed by means of washing fluid supplied and drained to and from the intermediate chamber by means of a first and a second valve, respectively, and by means of washing fluid supplied and drained to and from the washing chamber by means of the first and the second washing valve, respectively, whereby washing fluid is flowing through the back valve and the front valve into the process vessel or conduit, and whereby all valves in the probe body are operated sequentially.

12. A measuring method according to claim 9, characterized by that all the valves in the probe body are operated by means of inflation of a tube element arranged with its ends sealingly abutting a corresponding recess in the block, so that an air chamber is formed between the outer periphery of the tube element and the probe body, whereby air is supplied to the air chamber of each tube element from a separate air supply.
